(19) United States
(12) Patent Application Publication
(10) Pub. No.: US 2026/0133618 A1
(43) Pub. Date: May 14, 2026

(54) OPERATING SYSTEM FOR POWER-AWARE SMART AIDS TO NAVIGATION AND OPERATING METHOD THEREOF

(71) Applicant: Korea Electronics Technology Institute, Seongnam-si (KR)

(72) Inventors: In Pyo CHO, Yongin-si (KR); Sang Yub LEE, Yongin-si (KR); Jae Kyu LEE, Yongin-si (KR); Ki Won KWON, Seongnam-si (KR); Sung Yoon CHO, Seoul (KR)

(21) Appl. No.: 19/176,748

(22) Filed: Apr. 11, 2025

Related U.S. Application Data
(63) Continuation of application No. PCT/KR2025/001839, filed on Feb. 7, 2025.

(30) Foreign Application Priority Data
Nov. 14, 2024 (KR) 10-2024-0162480

(51) Int. Cl. G06F 1/3296

(52) U.S. Cl. CPC G06F 1/3296

(57) ABSTRACT

Proposed is an operating method of an operating system for power-aware smart aids to navigation. The operating method may be an operating method of an operating system for power-aware smart aids to navigation, including service blocks implemented through a microservice architecture and independently operated in a container environment. The method may include determining an operation mode of the operating system for power-aware smart aids to navigation by using an operating module, based on a power supply state. The method may also include selecting control target service blocks from among the service blocks in the determined operation mode by using the operating module.

### CROSS REFERENCE TO RELATED APPLICATIONS

This is a continuation application of International Patent Application No. PCT/KR2025/001839 filed on Feb. 7, 2025, which claims priority to Korean patent application No. 10-2024-0162480 filed on Nov. 14, 2024, contents of each of which are incorporated herein by reference in their entireties.

### BACKGROUND

### Technical Field

The present disclosure relates to a microservice architecture for effectively managing multi-services in smart aids to navigation and an operation thereof.

### Description of Related Technology

In aids to navigation (ATONs), complicated hardware modules (a sensor, a power supply, a communication device, etc.) are integrated and operated. To efficiently manage such a system, operating frameworks based on open source software (OSS) are essential. However, in conventional OSS projects, system performance and stability may be reduced due to problems such as memory leakage and system shutdown. Particularly, in ATONs requiring high availability, such a problem may be considerably severe, and in terms of a characteristic of ATONs where power should be maintained based on only solar photovoltaic, a problem of power management is very important.

### SUMMARY

One aspect is a power-aware operating framework which includes a prediction maintenance and power management function based on a microservice architecture (MSA) and machine learning (ML).

Another aspect is a power management strategy which may solve the variability of power supply and a system reliability problem and may be more efficient and reliable.

Another aspect is a power-aware operating frame that introduces a microservice architecture where each service may be independently operated, based on the variability of power supply and the stability of a system, and dynamically adjusts an operation mode of the system according to a power situation, thereby optimizing energy consumption. Also, the present disclosure previously predicts a hardware fault and enables a response thereto, through a prediction maintenance function based on machine learning, thereby ensuring a continuous operation of a system.

Another aspect is an operating method of an operating system for power-aware smart aids to navigation, including service blocks implemented through a microservice architecture and independently operated in a container environment, and includes: a step of determining an operation mode of the operating system for power-aware smart aids to navigation by using an operating module, based on a power supply state; and a step of selecting control target service blocks from among the service blocks in the determined operation mode by using the operating module.

Another aspect is an operating system for power-aware smart aids to navigation, including service blocks implemented through a microservice architecture and independently operated in a container environment, that includes: a processor; and an operating module independently operated in a container environment executed by the processor, wherein the operating module determines an operation mode of the operating system for power-aware smart aids to navigation, based on a power supply state, and selects control target service blocks from among the service blocks in the determined operation mode.

According to the present disclosure, in terms of power management optimization, there is an advantage where a performance mode of a system is adjusted according to a power supply situation, based on a dynamic power management strategy.

In terms of the reinforcement of system stability, each service is independently operated in a container environment, and thus, there is an advantage where an entire system is not affected by a problem such as memory leakage.

In terms of the enhancement of operation efficiency, the present disclosure may previously sense and respond to a hardware fault through a prediction maintenance function based on machine learning, and thus, has an advantage which may minimize a downtime of a system.

### BRIEF DESCRIPTION OF THE DRAWINGS

FIG. 1 is a diagram illustrating a microservice architecture for an operating system for power-aware smart aids to navigation according to an embodiment of the present disclosure.

FIG. 2 is an exemplary diagram of a service operation in a high performance mode in a microservice architecture for an operating system for power-aware smart aids to navigation according to an embodiment of the present disclosure.

FIG. 3 is an exemplary diagram of a service operation in a low performance mode in a microservice architecture for an operating system for power-aware smart aids to navigation according to an embodiment of the present disclosure.

FIG. 4 is a flowchart illustrating an operating method of an operating system for power-aware smart aids to navigation according to an embodiment of the present disclosure.

FIG. 5 is an exemplary configuration diagram of a computing device performing the method of FIG. 4.

### DETAILED DESCRIPTION

In the following description, the technical terms are used only for explaining a specific embodiment while not limiting the present disclosure. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

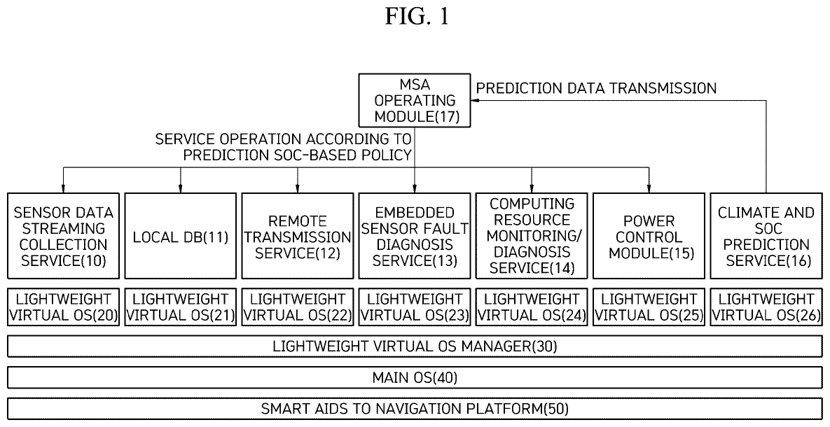

FIG. 1 is a diagram illustrating a microservice architecture for an operating system for power-aware smart aids to navigation according to an embodiment of the present disclosure.

Referring to FIG. 1, in an operating framework for power-aware smart aids to navigation according to an embodiment of the present disclosure, several function modules are implemented through a microservice architecture (MSA).

Each function of the MSA is configured with independent container-based service blocks 10 to 17, and the container-based service blocks 10 to 17 are executed in a lightweight container environment. Such a container-based architecture is capable of independent distribution, extension, and restart of an individual service, and thus, is designed so that an entire system is not affected by a problem such as memory leakage.

A container-based sensor data collection service block 10 collects data from various sensors in real time, evaluates a state of hardware, based on the data, and is used to establish a power management strategy.

A container-based local database (DB) service block 11, for example, stores collected sensor data in a local DB by using MongoDB. A database is containerized and is independently managed, and thus, increases the efficiency of data access and processing. MongoDB is NoSQL (non-relational) database and is a document-oriented database which is optimized for the storage and management of massive data. MongoDB stores data as BSON (Binary JSON) document similar to JSON form instead of a table and a row, and thus, may flexibly store various data structures.

A container-based remote transmission service block 12, for example, remotely transmits sensor data by using message queuing telemetry transport (MQTT) protocol. This enables stable and efficient transmission and minimizes data loss. Here, MQTT is lightweight message transmission protocol. MQTT provides an efficient method for communication between remote devices and is protocol which is designed to stably operate a network environment where a bandwidth is limited.

A container-based fault diagnosis service block 13 previously predicts and diagnoses a hardware fault by using a machine learning (ML) algorithm. Such a prediction model learns past data to analyze current data and senses an abnormal state of hardware to transmit a warning to a manager or automatically solve a problem.

A container-based computing resource monitoring/diagnosis service block 14 monitors a state of a system in real time by using a software program such as Prometheus and Grafana and diagnoses the amount of use of resources. The container-based computing resource monitoring/diagnosis service block 14 previously senses a problem which may occur in a system, and based thereon, sends alerting to a manager or automatically responds thereto. Prometheus and Grafana are open source-based monitoring and visualization tools and provides a solution which may monitor and analyze in real time the performance and state of a system by using the tools together. Prometheus, for example, is an open source system for monitoring and warning and is mainly used to collect and store time-serial data (data varying over time). To collect time-serial data, for example, Prometheus stores time-serial data collected in various sources such as a server, an application, and a database. Time-serial data, for example, may be collected in a metrics form. To support various data sources, for example, Prometheus may use a Pull model which collects data through an HTTP request and may install Exporters in various monitoring targets, and thus, may automatize data collection. For example, server resources, application performance, and a database state are monitored in real time through Exporter. For a warning system, for example, Prometheus may set alerting rules, and when a system state exceeds a specific threshold value, Prometheus may trigger a warning. A warning may be transmitted through various channels such as E-mail and Slack. Prometheus, for example, may provide a unique query language such as Prometheus query language (PromQL) to analyze time-serial data and may assign a condition to set a complicated monitoring rule. Grafana may be an open source dashboard and visualization tool for visualizing and analyzing data and may fetch and visualize data in various data sources such as Prometheus. To support various visualizations, for example, Grafana may provide various visualization options such as a graph, a chart, a gauge, and a rod showing data variation over time and may thus allow monitoring data to be easily checked. To generate a dashboard, Grafana may generate a dashboard capable of customizing and may monitor several metrics in real time. A dashboard may be easily configured based on a drag and drop method, and thus, may be user-friendly. To integrate various data sources, for example, Grafana may be integrated with several data sources such as ElasticSearch, InfluxDB, and MySQL in addition to Prometheus, and thus, data of a heterogeneous database may be managed in one screen. For connection of warning and alerting, for example, Grafana may set a user definition warning and may send alerting in real time through a channel such as E-mail, Slack, or Webhook. Prometheus concentrates in collecting and storing data, and Grafana is a method which visualizes data collected in Prometheus to provide to a user and is capable of a cooperation between Grafana and Prometheus. As described above, the computing resource monitoring/diagnosis service block 14 may effectively implement real-time system state monitoring, resource usage diagnosis, a previous problem sensing and warning function through a cooperation between a monitoring tool (a monitoring software program) such as Prometheus and a visualization tool (a visualization software program) such as Grafana.

The MSA operating module 17 operates to control activation and deactivation of the service blocks 10 to 14 according to a prediction SoC-based policy, based on state of charge (SoC) prediction data and a climate received from a climate and SoC prediction service block 16.

Lightweight virtual operating systems (OSs) 20 to 26 provided for each container-based service block are OSs having a structure which is more lightweight than a conventional virtual machine (VM) and execute a container-based service block independently corresponding thereto. Such a lightweight virtual OS may be, for example, Linux container (LXC).

A lightweight virtual OS manager 30 is a tool which manages several lightweight virtual OSs. The lightweight virtual OS manager 30 may automatically manage and adjust several containers to support the efficient use of resources, and depending on the case, may passively adjust the number of containers.

The main OS 40 may be an OS which provides a user-friendly interface and various packages, and for example, may be Ubuntu which is a kind of Linux distribution.

A smart aids to navigation platform 50 may include a storage device, a communication module, and a processor (a central processing unit (CPU), a neural processing unit (NPU), and a graphics processing unit (GPU)) and may be hardware which collects and processes data.

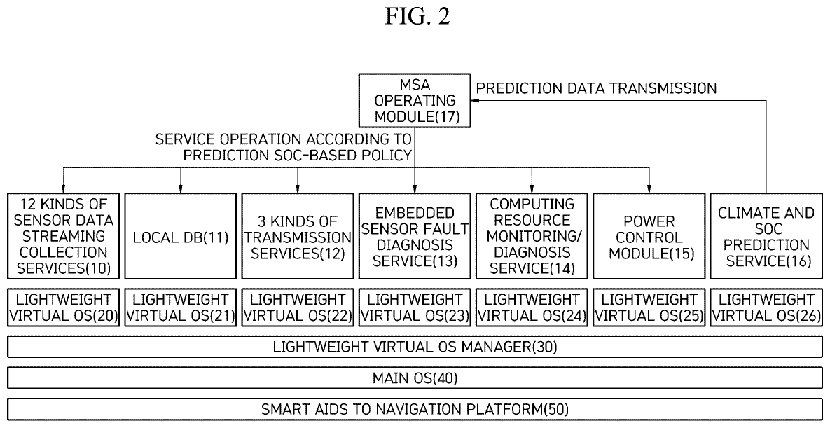

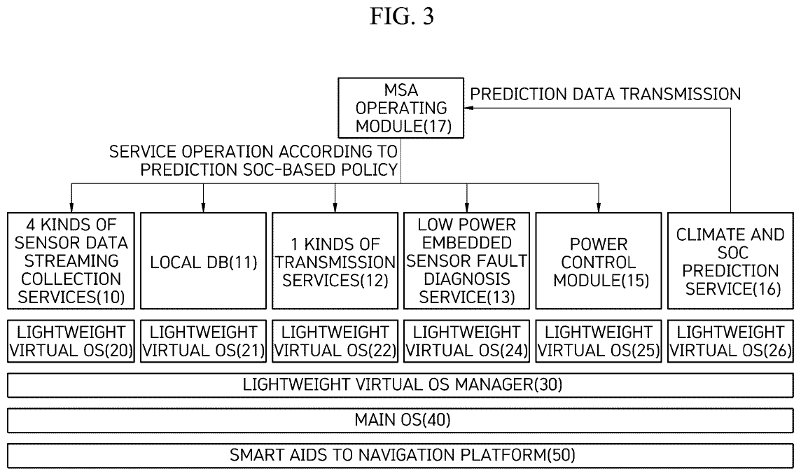

FIG. 2 is an exemplary diagram of a service operation in a high performance mode in a microservice architecture for an operating system for power-aware smart aids to navigation according to an embodiment of the present disclosure, and FIG. 3 is an exemplary diagram of a service operation in a low performance mode in a microservice architecture for an operating system for power-aware smart aids to navigation according to an embodiment of the present disclosure.

Referring to FIGS. 2 and 3, in OS for smart aids to navigation for power-aware dynamic management, because power supply depends on sunlight energy, a power situation may be very variable. Therefore, an embodiment of the present disclosure provides a function which may dynamically adjust an operation mode of a system, based on a power supply state (for example, a power supply state of a sunlight power). The operation mode according to an embodiment includes a high performance mode, a middle performance mode, and a low power mode. In the high performance mode, as illustrated in FIG. 2, for example, the sensor data collection service block 10 may collect 12 kinds of sensor data by using 12 kinds of sensors, and the remote transmission service block 12 provides 3 kinds of remote transmission services. In the low power mode, as illustrated in FIG. 3, for example, the sensor data collection service block 10 may provide 4 kinds of sensor data collection services by using 4 kinds of sensors, and the remote transmission service block 12 may provide 1 kind of remote transmission service.

In the high performance mode, when a sufficient sunlight power is predicted, a system operates all service blocks with maximum performance. In such a mode, all sensors are activated, and data collection and transmission are performed in real time. Such a mode is high in energy consumption, but collects and analyzes accurate data by maximally using the performance of a system.

In the middle performance mode, when a sunlight power is uncertain, a system maintains the activation of only essential service block(s) and deactivates an unessential service block(s). In such a mode, energy consumption is reduced, and an important service is ensured to be continuously operated. For example, core sensor data is still collected, but a non-core service or an additional analysis operation is temporarily stopped (deactivated).

In the low power mode, when a sunlight power is insufficient, a system is changed to the low power mode which consumes only minimum energy. In such a mode, only a service block(s) associated with a communication module and a core sensor is activated, and all the other service blocks are deactivated. Based on such a method, a system minimizes energy consumption to increase a battery lifetime and maintains only a basic navigation aid function. Here, the core sensor is a sensor which is essential for monitoring a peripheral environment and state so that aids to navigation functions stably and effectively, and for example, may be a global positioning system (GPS) sensor, an environment sensor (a weather sensor, a illumination sensor, and a wind speed and direction sensor), a wave and tide sensor, a power monitoring sensor, a radar reflector, and a collision prevention sensor. A service block(s) associated with the core sensor may be, for example, the container-based sensor data collection service block 10, the container-based climate and SoC prediction service block 16, and a container-based power control module 15. Also, a service block(s) associated with a communication module may be, for example, the remote transmission service block 12.

Hereinafter, a selection and a policy of a control target service block in each operation mode dynamically adjusted will be described.

The present disclosure provides a policy which dynamically selects a control target service block(s), based on the amount of use of resources and a significance of each service block in operating of a system. In terms of a power management strategy, a system controls each service, overall based on the amount of use of hardware (HW) resources (the amount of use of CPU and GPU and the amount of power consumption of relevant hardware) and a significance of service, which are set by a user.

In an embodiment, a system may set a significance of each service block(s), and a service having high significance is maintained when a sunlight power is insufficient. A priority is determined between service blocks where significances thereof are equal to one another or are not set, based on the amount of use of resources.

In an embodiment, in association with monitoring of the amount of use of hardware (HW) resources, the amount of power consumption of relevant hardware and a CPU and GPU share ratio of each service block may be monitored, and thus, a service block which is high in amount of use of resources may be to be deactivated when power is insufficient.

In an embodiment, in association with a selection of a control target service, parameters determining a service control priority may be, for example, a significance of each service block, the amount of use of HW resources (CPU and GPU share ratio), and the amount of power consumption of corresponding service block(s). Such parameters are overall evaluated, and based on a power situation, a service block to deactivate is determined.

The following Table 1 is an exemplary table where control priorities of services are calculated.

TABLE 1

| Service | | HW | CPU/GPU | Control |
|---|---|---|---|---|
| Block | Significance | Power | Share Ratio | Priority |
| S1 | 1 | 70 | 30 | 10 |
| S2 | 2 | 80 | 30 | 9 |
| S3 | 3 | 100 | 40 | 7 |
| S4 | 3 | 90 | 20 | 8 |
| S5 | 3 | 100 | 50 | 6 |
| S6 | 4 | 90 | 40 | 5 |
| S7 | 4 | 100 | 30 | 4 |
| S8 | — | — | 60 | 2 |
| S9 | — | — | 40 | 3 |
| S10 | — | 100 | 50 | 1 |

Factors evaluating priorities of services are as follows.
1. Significance of service block(s) (I): represents a significance of each service set by a user. Significances may be set to integer values of 1 to 5, 1 denotes a lowest significance, and 5 denotes a highest significance.
2. The amount of use of hardware (HW) resources (R): the amount of use of HW resources of each service may be calculated as a weight sum of a CPU share ratio and a GPU share ratio. For example, by reflecting relative significances of a CPU share ratio and a GPU share ratio, the amount of use of HW resources of each service may be defined as in the following Equation 1. Here, α is a weight of a CPU share ratio, and β is a weight of a GPU share ratio.

$${R}_{i} = α \cdot {C}_{i} + β \cdot {G}_{i} \qquad EQUATION 1$$

3. The amount of power consumption of power (P): denotes power consumed by each service. Such a value may be measured to be the absolute amount of power consumption of power (Watt unit).
4. A priority score of service(S): a priority score of service I is calculated to be a weight sum of the amount of power consumption, the amount of use of HW resources, and a significance of each service block(s). This may be represented by the following Equation 2.

$${S}_{i} = γ \cdot {I}_{i} + δ \cdot {R}_{i} + ε \cdot {P}_{i} \qquad EQUATION 2$$

γ is a weight of service significance, and o is a weight of the amount of use of hardware (HW) resources. Also, ¿ is a weight of power consumption.
5. A selection of service priority: an S value of each service is calculated, and then, based on the value, a control priority is determined by aligning services. As the S value increases, a possibility that a corresponding service is maintained is high, and as the value decreases, a priority of deactivation is put when power is insufficient.

In association with fault sensing and response thereto, an embodiment of the present disclosure integrates a fault sensing and prediction system based on machine learning to increase the reliability of smart ATONs. The system analyzes past operation data to determine a symptom of a hardware fault, and based thereon, previously predicts a fault. When the fault is predicted, the system immediately starts a corresponding process. For example, when a container where a problem occurs restarts automatically, or it is unable to solve the problem, the system returns to a previous stable state. Also, the system transfers detailed information about a fault to a manager in real time, and thus, supports to enable a quick response.

In association with the extension and flexibility of a system, an embodiment of the present disclosure is designed based on the extension of the system. A new sensor or service module may be easily added, and a conventional module may be expanded or changed to another container. Also, the flexibility of the system is maximized to adapt to various environment conditions. For example, an operating method of the system may be adjusted based on various climate conditions, and a flexible power management strategy capable of responding to various power supply scenarios is provided.

As described above, the present disclosure provides a power-aware operating framework for maximizing efficiency and reliability in operating of smart ATONs. The framework solves main problems of an auxiliary apparatus for smart aids to navigation and enables a stable operation in various environments.

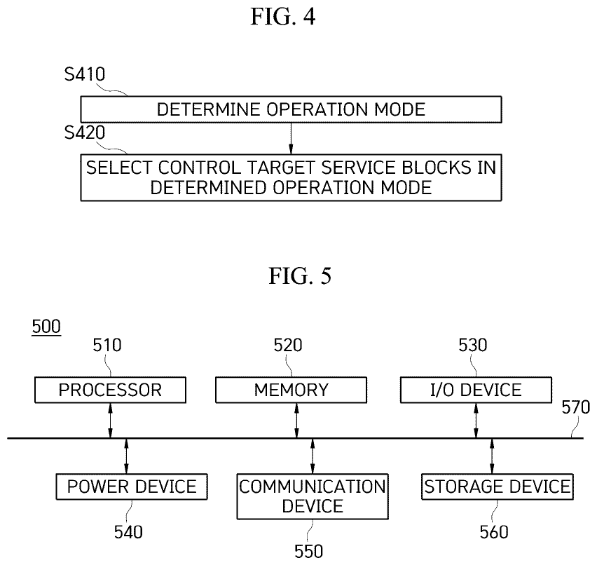

FIG. 4 is a flowchart illustrating an operating method of an operating system for power-aware smart aids to navigation according to an embodiment of the present disclosure.

Referring to FIG. 4, the operating system for power-aware smart aids to navigation according to an embodiment of the present disclosure includes the service blocks 10 to 17 implemented through a microservice architecture and includes the containerized service blocks 10 to 17 which are independently operated in a container environment. Such an operating method of an operating system largely includes step S410 of determining an operation mode of the operating system for power-aware smart aids to navigation by using an operating module, based on a power supply state, and step S420 of selecting control target service blocks among the service blocks by using the operating module in the determined operation mode.

In an embodiment, the operation mode determined in the step S410 includes the high performance mode which operates all of the service blocks 10 to 17 with maximum performance in an environment where a sufficient sunlight power is predicted, the middle performance mode which operate to activate essential service blocks and deactivate unessential service blocks among the service blocks 10 to 17 in an environment where a sunlight power is uncertain, and a low power mode which activates only service blocks associated with a core sensor and a communication module among the service blocks in an environment where a sunlight power is insufficient. Here, for example, the operating module 17 may determine whether a sunlight power is sufficient or uncertain or insufficient, based on prediction data (i.e., data obtained by predicting a climate state and an SoC state) provided by the climate and SoC prediction service block 16 among the service blocks.

In an embodiment, the step S420 of selecting the control target service blocks includes a step of selecting the control target service blocks, based on a significance of each of service blocks and the amount of use of resources of each service block. At this time, when the significances are equal to one another, the control target service blocks may be selected based on a priority determined based on the amount of use of resources.

In an embodiment, the amount of use of resources of each service block may include a CPU share ratio, a GPU share ratio, and the amount of power consumption of relevant hardware.

In an embodiment, the step S420 of selecting the control target service blocks may be to select the control target service blocks, based on parameters including a significance of each service block, the amount of use of resources, and the amount of power consumption of each service block.

In an embodiment, the step S420 of selecting the control target service blocks may be to select the control target service blocks, based on a service priority score, and the service priority score may be calculated to be a weight sum of a significance of each service block, the amount of use of resources, and the amount of power consumption.

FIG. 5 is an exemplary configuration diagram of a computing device performing the method of FIG. 4.

Referring to FIG. 5, in a computing device 500, service blocks implemented through a microservice architecture are main elements which respectively perform the steps in the method of FIG. 4. That is, the computing device 500 controls, executes, and/or manages the service blocks 10 to 17, the lightweight virtual OSs 20 to 26, the lightweight virtual OS manager 30, the main operating system 40, and the smart aids to navigation platform 50 illustrated in FIGS. 1 to 3.

To this end, the computing device 500 includes a processor 510, a memory 520, an input/output (I/O) device 530, a power device 540, a communication device 550, a storage device 560, and a system bus 570 connecting the elements 510 to 560 with each other.

The processor 510 is an element which performs a core function of the computing device and analyzes and executes an assigned instruction. In an operating system for smart aids to navigation, the processor 510 performs functions such as sensor data collection, data processing, and operating algorithm execution and provides performance needed for real-time control and data processing. Also, the processor 510 controls, executes, and manages operations of the elements 10 to 17, 20 to 26, 30, 40, and 50 illustrated in FIGS. 1 to 3.

The memory 520 is a device which temporarily stores needed when the processor processes an operation. In a system for smart aids to navigation, a memory performs a function of quickly accessing and storing data and provides a temporary space for processing sensor data and logging information. The memory 520 includes a volatile memory and/or a non-volatile memory.

The I/O device 530 functions as an interface with a user or an external system. For example, an operator for aids to navigation may check a state of a system through the I/O device, or may input a desired control command. Also, the I/O device 530 provides an interface with various sensors or an actuator to collect environment information and outputs a desired control command. The input device includes a keyboard, a touch screen, and/or the like. The output device includes a speaker, a display device, and/or the like.

The power device 540 is a device which supplies power to the computing device and includes a battery charged with a sunlight power and a battery management system. In the operating system for smart aids to navigation, efficient and stable power supply is important, and depending on the case, the operating system supports a long-time operation through power supply using renewable energy or a battery backup system.

The communication device 550 performs a function of transmitting or receiving data through a connection with an external network. In the system for smart aids to navigation, the communication device 550 may transmit state data or may receive a remote control command in communication with a center management system. Generally, technology such as wireless communication or satellite communication is used.

The storage device 560 is a device which is used to store long-time data. The storage device 560 stores an operation history, state information, and an event log for aids to navigation, and then, is used for analysis and a problem solution.

The system bus 570 is a communication path which connects, with each other, all elements such as the processor 510, the memory 520, the I/O device 530, the power device 540, and the communication device 550. Therefore, the system bus 570 transmits or receives data between the elements and allows the system for smart aids to navigation to smoothly operate.

The embodiments described herein should be considered in terms of an exemplary perspective view for description instead of a limited perspective view. The scope of the present disclosure is described in claims instead of the above descriptions, and it should be construed that all differences within a range equivalent thereto are included in the present disclosure.

### INDUSTRIAL APPLICABILITY

The present disclosure has industrial applicability in the field of power-aware operating framework.

What is claimed is:

1. An operating method of an operating system for power-aware smart aids to navigation, including service blocks implemented through a microservice architecture and independently operated in a container environment, the operating method comprising:
determining an operation mode of the operating system for power-aware smart aids to navigation by using an operating module, based on a power supply state; and
selecting control target service blocks from among the service blocks in the determined operation mode by using the operating module.

2. The operating method of claim 1, wherein the operation mode comprises:
a high performance mode of operating all of the service blocks with maximum performance in an environment where a sufficient sunlight power is predicted;
a middle performance mode of operating to activate essential service blocks and deactivate unessential service blocks among the service blocks in an environment where a sunlight power is uncertain; and
a low power mode of activating only service blocks associated with a core sensor and a communication module among the service blocks in an environment where a sunlight power is insufficient.

3. The operating method of claim 1, wherein the selecting the control target service blocks from among the service blocks comprises selecting the control target service blocks, based on a significance of each of the service blocks and the amount of use of resources of each service block.

4. The operating method of claim 3, wherein selecting the control target service blocks from among the service blocks comprises selecting the control target service blocks when the significances are equal to one another, based on a priority determined based on the amount of use of resources.

5. The operating method of claim 3, wherein the amount of use of resources of each service block comprises a CPU share ratio, a GPU share ratio, and the amount of power consumption of relevant hardware.

6. The operating method of claim 1, wherein selecting the control target service blocks from among the service blocks comprises selecting the control target service blocks, based on parameters including a significance of each service block, the amount of use of resources, and the amount of power consumption of each service block.

7. The operating method of claim 1, wherein selecting the control target service blocks from among the service blocks is to select the control target service blocks, based on a service priority score, and
wherein the service priority score is calculated to be a weight sum of a significance of each service block, the amount of use of resources, and the amount of power consumption.

8. An operating system for power-aware smart aids to navigation, including service blocks implemented through a microservice architecture and independently operated in a container environment, the operating system comprising:
a processor; and
an operating module independently operated in a container environment executed by the processor,
wherein the operating module is configured to determine an operation mode of the operating system for power-aware smart aids to navigation, based on a power supply state, and select control target service blocks from among the service blocks in the determined operation mode.
